(19) United States
(12) Patent Application Publication
(10) Pub. No.: US 2012/0320374 A1
(43) Pub. Date: Dec. 20, 2012

(54) METHOD OF IMAGING AND INSPECTING THE EDGE OF AN OPHTHALMIC LENS

(76) Inventors: Peter W. Sites, Orange Park, FL (US); Russell J. Edwards, Jacksonville, FL (US); Kenneth L. Cagle, Saint Marys, GA (US)

(21) Appl. No.: 13/484,081

(22) Filed: May 30, 2012

Related U.S. Application Data
(60) Provisional application No. 61/498,220, filed on Jun. 17, 2011.

(51) Int. Cl. G01N 21/958

(52) U.S. Cl. 356/239.2

(57) ABSTRACT

Systems for producing images of the edges of silicone hydrogel ophthalmic lenses are disclosed.

### FIELD OF THE INVENTION

This invention relates to the inspection of ophthalmic lenses, particularly silicone hydrogel contact lenses for defects to the edge.

### BACKGROUND OF THE INVENTION

Ophthalmic lenses, such as hydrogel contact lenses are formed, inspected, and packaged on manufacturing lines with minimal human intervention. During these processes, certain defects to those lenses occur particularly to the edge of the lens. Edges may be torn or malformed in other ways and such defects should be removed from the product that ultimately reaches end users.

The best way to inspect a lens edge is to get a clear image of the edge. There are inspection methods, which produce images of lens edges. However, given the variety of different types of contact lens materials, particularly silicone hydrogels, it is difficult to get a clear image because the image appears washed out. Therefore, it is desirable to find a method of producing a clear image of a lens edge and ultimately inspect that image. This desire is met by the foregoing invention.

### DESCRIPTION OF THE FIGURES

FIG. 1 Image of an ophthalmic lens with a partially unclear edge.

FIG. 2 Partial system of the invention

FIG. 3 Light rays passing through regions of a lens' edge and its background.

FIG. 4 Light rays passing through the edge.

FIGS. 5a and 5b Centered and off centered lens images

### DETAILED DESCRIPTION OF THE INVENTION

This invention provides an imaging system which produces an image of an edge of a silicone hydrogel ophthalmic lens and it background wherein the ophthalmic lens comprises an edge, an interior section adjacent to and surrounded by the exterior section, and said background is adjacent to the edge and encloses the ophthalmic lens, wherein the imaging system comprises

an entrance pupil

a light source which emits rays that fall on the background and the ophthalmic lens
wherein substantially all of the rays pass through on the background and the interior section of the ophthalmic lens pass through the entrance pupil
wherein the majority of the rays that pass through the edge of the ophthalmic lens do not pass through the entrance pupil, and

image formation area.

As used herein the term “silicone hydrogel ophthalmic lens” refers to soft contact lenses made with monomers, macromers or prepolymers which contain silicone. Examples of such ophthalmic lenses include but are not limited to lenses made from the following generic formulations balafilcon, lotrafilcon, galyfilcon, enfilcon, comfilcon, senofilcon, and narafilcon. The preferred silicon hydrogel ophthalmic lens are made from the following formulations comfilcon, galyfilcon, senofilcon, and narafilcon. The particularly preferred ophthalmic lenses are made from the following formulations galyfilcon, senofilcon, and narafilcon.

As used herein the term “edge” refers to the intersection of the back curve and front curve of the lens and about 0.1 mm in from that intersection on both curves. The term “interior section” refers to the remaining portions of the ophthalmic lens.

The term “background” refers to an area that is imaged which is outside of the lens. Preferably background includes the container that holds the silicone hydrogel and solution such as deionized water or saline solution. The term “entrance pupil refers to an aperture though which rays of the light that pass through the interior section and the background also pass through. Preferably the entrance pupil has a diameter of from about 1.3 mm to about 1.8 mm, preferably 1.6 mm.

As used herein light source means LED generated light. As used herein image formation area creates and captures the image. The preferred image formation area is a CCD camera and lens system.

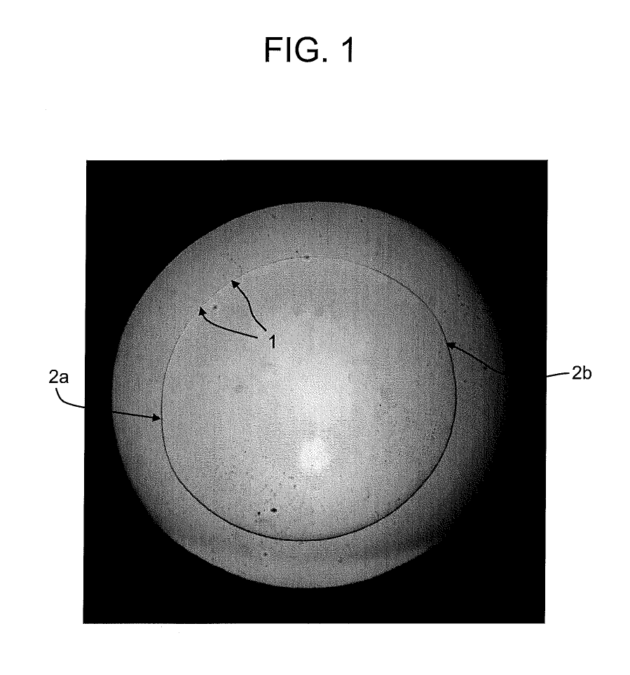

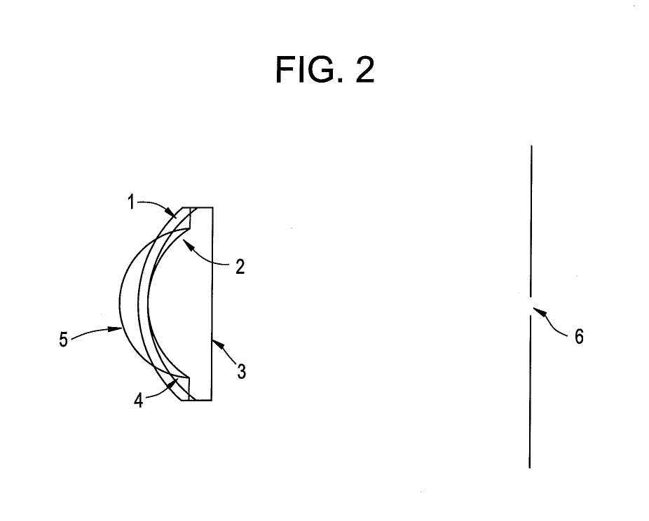

FIG. 1 illustrates an image of a narafilcon A lens which was not made using the systems of this invention. Between arrows 1, the edge of the lens is washed out and not clearly visible. Between arrows 2a and 2b, a clear lens edge is visible. FIG. 2 illustrates a portion of the systems of the invention. A container for the lenses, the surface of which is represented by 1 contains an ophthalmic lens whose back surface 2, and front surface 5 are shown. Region 4 of the lens is the exterior section and 3 is the level of water in the package. The entrance pupil is represented by portion 6.

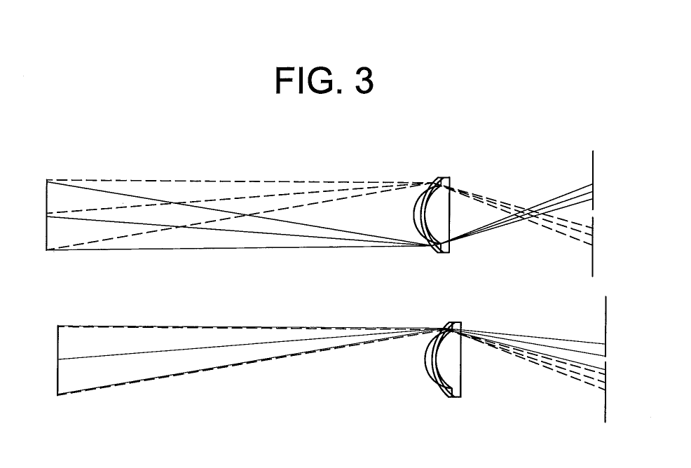

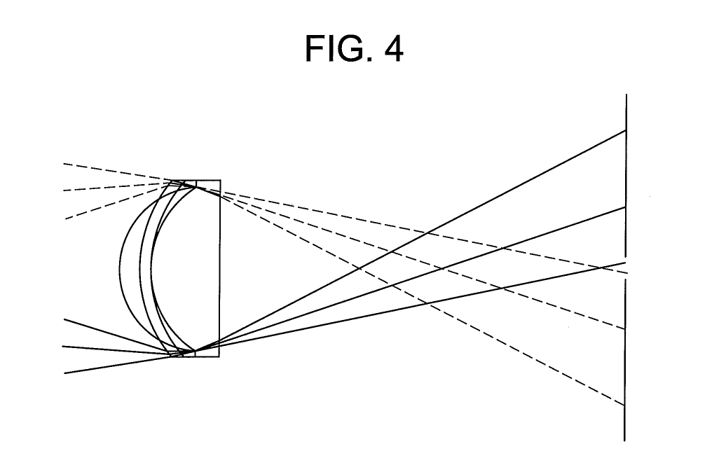

In FIG. 3 light passes through the ophthalmic lens and the background from the left and emerges on the right. The upper portion of FIG. 3 illustrates rays from a light source passing through the background and the edge of the lens and are deflected past the entrance pupil. In the lower portion of this figure, the rays of light represented by dashed and solid lines pass through different portions of the lens and the background. The solid lines that emerge from lower portion of FIG. 3 illustrates light passing through the background without passing through the lens The dashed lines that emerge from the lower portion of FIG. 3, pass through the background and the edge are deflected past the entrance pupil. FIG. 4 illustrates another embodiment of the invention where some of the rays which go through the edge go through the entrance pupil.

The image which is produced by the system of the invention may be described in terms of the intensity ratio of the image of the background, or interior section versus the image of the edge. The intensity is the grey scale measurement for a particular portion of the image. The intensity ratio is computed by dividing either the grey scale level for the background by the grey scale level of the edge or the grey scale level for the interior section by the grey scale level of the edge. Preferably the intensity ratio for the background vs. the edge is about 1.70 to about 2.10. Preferably the intensity ratio for the interior section vs. the edge is about 1.9 to about 2.2.

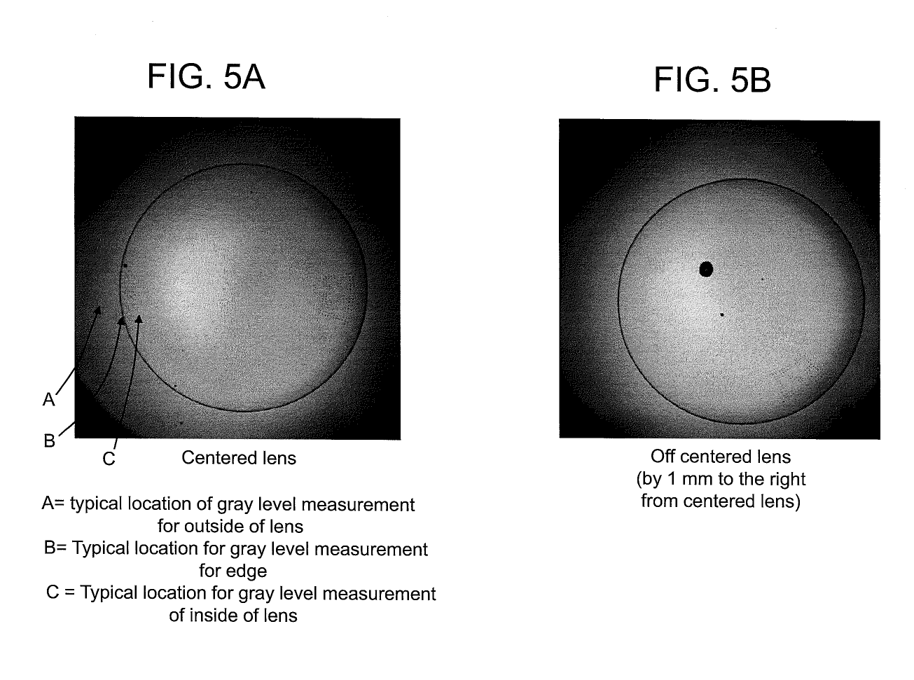

Given the fact that most silicone hydrogel ophthalmic lenses are imaged and inspected on a moving manufacturing line, lenses are often not centered within their background. This movement makes it difficult to obtain an image of an edge. However, one of the advantages of the systems of the invention is that even if an ophthalmic lens moves by about 1 mm, a clear image of that edge may still be formed. FIG. 5a illustrates a centered image and 5b is an image that is 1 mm off centered.

The imaging system of this invention may be incorporated in a number of inspection techniques. Non-limiting examples of such techniques are disclosed in the following patents U.S. Pat. Nos. 6,882,411, 6,577,387, 6,246,062; 6,154,274; 5,995,213; 5,943,436; 5,828,446; 5,812,254; 5,805,276; 5,748,300; 5,745,230; 5,687,541; 5,675,962; 5,649,410; 5,640,464; 5,578,331; 5,568,715; 5,443,152; 5,528,357; and 5,500,732; all of which are incorporated herein in their entireties by reference.

We claim:

1. An imaging system which produces an image of an edge of a silicone hydrogel ophthalmic lens and it background wherein the ophthalmic lens comprises an edge, an interior section adjacent to and surrounded by the exterior section, and said background is adjacent to the edge and encloses the ophthlamic lens, wherein the imaging system comprises
an entrance pupil
a light source which emits rays that fall on the background and the ophthalmic lens
wherein substantially all of the rays pass through on the background and the interior section of the ophthalmic lens pass through the entrance pupil
wherein the majority of the rays that pass through the edge of the ophthalmic lens do not pass through the entrance pupil, and
image formation area.

2. The system of claim 1 which produces an image having an intensity ratio for the interior zone to the edge of about 1.9 to about 2.2.

3. The system of claim 1 which produces an image having a intensity ratio for the background to the edge of about 1.7 to about 2.1.

4. The system of claim 1 wherein the background comprises a package and deionized water.

5. The system of claim 1 wherein said ophthalmic lenses is selected from the group consisting of balafilcon, lotrafilcon, galyfilcon, enfilcon, comfilcon, senofilcon, and narafilcon.
